(19) United States
(12) Patent Application Publication
(10) Pub. No.: US 2026/0063235 A1
(43) Pub. Date: Mar. 5, 2026

(54) Pressure Seal Device for Large-Diameter High-Temperature, High-Pressure, Long-Distance Thermal Pipeline

(71) Applicant: Jinan Huitong Heat Co., Ltd., Jinan (CN)

(72) Inventors: Zonggang LI, Jinan (CN); Chenglei Yin, Jinan (CN); Qingzhen Zhai, Jinan (CN); Hai Lin, Jinan (CN); Yanpei Feng, Jinan (CN)

(21) Appl. No.: 19/243,692

(22) Filed: Jun. 20, 2025

(30) Foreign Application Priority Data
Sep. 3, 2024 (CN) 202411223000.8

(51) Int. Cl. F16L 55/168

(52) U.S. Cl. CPC F16L 55/1683

(57) ABSTRACT

A pressure seal device for large-diameter high-temperature, high-pressure, long-distance thermal pipeline, includes a seal plate, wherein the seal plate is provided with an electromagnet and a first sealing strip, the seal plate is provided with a drainage pipeline, and one end of the drainage pipeline is provided with a first flange; the pressure seal device further includes a drainage belt and a connecting pipeline, wherein one end of the connecting pipeline is provided with a second flange detachably connected to the first flange, and an other end of the connecting pipeline is provided with a drainage opening, the drainage belt is mounted around the drainage opening, the drainage pipeline is provided with an on-off gate valve; the device further includes a flange plate detachably connected to the first flange, a first weld seam is provided between the seal plate and the thermal pipeline.

### CROSS-REFERENCE TO RELATED APPLICATIONS

The present application claims the priority of Chinese Patent Application No. 202411223000.8, filed on Sep. 3, 2024, the entire contents of which are hereby incorporated by reference.

### TECHNICAL FIELD

The present disclosure relates to the technical field of pressure sealing for thermal pipelines, and in particular to a pressure seal device for large-diameter high-temperature, high-pressure, long-distance thermal pipeline.

### BACKGROUND

Large-diameter, high-temperature, high-pressure long-distance thermal pipelines serve as the main conduits for external heat supply into urban areas and form the backbone of urban heating networks. These pipelines cover extensive heating areas, and constitute the “lifeline” of urban heating systems, representing critical municipal infrastructure projects. Particularly during heating seasons, any operational issues in these long-distance networks are strictly prohibited, and pipeline shutdowns are absolutely unacceptable. However, due to their extensive routing and complex paths, long-distance pipelines and urban heating main pipelines often traverse rivers, highways, railways, subways, optical cables, farmland, and densely populated urban areas, causing their surrounding environments highly complex. In cases of accidental damage caused by third-party construction or natural disasters, leak sealing with pressure and emergency repairs must be conducted without interrupting pipeline operations. The return water pipes in long-distance thermal pipelines typically operate at temperatures below 45° C. and pressures under 1.8 MPa, allowing conventional method of sealing with pressure to be applied under proper safety precautions. However, if leaks occur in supply pipes, in which water temperatures generally reach around 100° C. and pressures exceed 1.8 MPa, it will create heavy steam with poor visibility. At this situation, if the conventional method of direct leak sealing with pressure in a manual manner is used, major personnel scalding accidents are very likely to occur. While conventional sealing could theoretically be performed after reducing pipeline pressure and temperature (below 60° C.) to meet safety requirements, this approach would require prohibitively long downtime (4-5 days just for cooling). Such extended repair periods would cause large-scale, prolonged heating interruptions, severely impacting residents' normal living conditions in affected areas.

### SUMMARY

An object of the present disclosure is to provide a pressure seal device for large-diameter high-temperature, high-pressure, long-distance thermal pipeline, which solves the problem of being unable to perform rapid sealing with pressure on such pipelines, reducing the risk of scalding for operators during close range installation, improving both the efficiency and effectiveness of sealing leak points in thermal pipelines.

In order to achieve the above objective, technical solutions of the present disclosure provide as follows:

A pressure seal device for large-diameter high-temperature, high-pressure, long-distance thermal pipeline, including a seal plate covering a leak point of a thermal pipeline, wherein the seal plate is provided with an electromagnet to be engaged with the thermal pipeline, and a first sealing strip in contact with the thermal pipeline, the seal plate is provided with a drainage pipeline, and one end of the drainage pipeline is provided with a first flange; the pressure seal device further includes a drainage belt and a connecting pipeline, wherein one end of the connecting pipeline is provided with a second flange detachably connected to the first flange, and an other end of the connecting pipeline is provided with a drainage opening, the drainage belt is mounted around the drainage opening, the drainage pipeline is provided with an on-off gate valve; the pressure seal device further includes a flange plate detachably connected to the first flange, a first weld seam is provided between the seal plate and the thermal pipeline.

Further, both sides of the seal plate are respectively provided with a plurality of force-applying handles and lifting lugs.

Further, a second sealing strip is provided between the seal plate and the thermal pipeline, and the second sealing strip is spaced apart from the first sealing strip by a distance; the seal plate is provided with sealing grooves, and the first sealing strip and the second sealing strip are embedded in the sealing grooves of the seal plate.

Further, a second weld seam and a third sealing strip are provided between the flange plate and the first flange.

Further, the seal plate is provided with a plurality of grid-shaped reinforcing ribs, and the seal plate is in an inverted flared shape.

Further, the drainage opening is provided with a protrusion, and the protrusion is provided with a fourth sealing strip in contact with the drainage belt; two clamps are respectively mounted around the drainage belt, and the two clamps are respectively located above and below the protrusion.

Further, the seal plate is provided with a plurality of screw rods, and the electromagnet is provided with a plurality of through holes for the screw rods to pass through; each screw rod is threadedly connected with a nut that is in contact with the electromagnet.

Further, the seal plate is made of steel plates welded together.

Further, the pressure seal device further includes a plurality of fixing rods, each of the first flange, the second flange, and the flange plate is provided with a plurality of penetrating holes for the plurality of fixing rods to pass through; a locking spring is provided between each fixing rod and the first flange; two limit blocks are slidably and symmetrically connected to an end of each fixing rod, one side of each limit block contacts the second flange or the flange plate, and an other side of each limit block is provided with a first inclined surface contacting the first flange, the second flange, and the flange plate; a reset spring is provided between the two limit blocks.

Further, a locking block is threadedly connected to an end of each fixing rod, an end of each limit block is provided with a second inclined surface, and an end of each locking block is provided with a conical surface in contact with a corresponding second inclined surface.

Compared with the prior art, the advantageous effects of the present disclosure are as follows:
1. Through the detachable connection between the first flange and the second flange enables pre-assembly of the connecting pipeline with the drainage pipeline, and the drainage belt is mounted around the drainage opening, so as to complete the pre-assembly of the seal device, which facilitates rapid sealing of the leak point of the large-diameter high-temperature, high-pressure, long-distance thermal pipeline, and improves the sealing efficiency of the thermal pipeline.

When a leak occurs in the large-diameter high-temperature, high-pressure, long-distance thermal pipeline, the configuration among the thermal pipeline, seal plate, leak point, electromagnet, and first sealing strip achieves temporary sealing at the leak point of the large-diameter high-temperature, high-pressure, long-distance thermal pipeline. This prevents continuous leak of high-temperature, high-pressure water from the leak point of the large-diameter high-temperature, high-pressure, long-distance thermal pipeline, avoiding scalding injuries to emergency maintenance personnel.
2. Through the configuration of the drainage pipeline, on-off gate valve, connecting pipeline, drainage opening, and drainage belt, the device effectively diverts high-temperature, high-pressure water from the leak point of the large-diameter high-temperature, high-pressure, long-distance thermal pipeline to a safe discharge area. This configuration relieves the pressure exerted by the high-temperature, high-pressure water on the seal plate and prevents the high-temperature, high-pressure water from directly washing away the seal plate. This configuration also prevents some of the high-temperature, high-pressure water from directly breaking through the sealing of the first scaling strip and leaking from the gap between the seal plate and the thermal pipeline, avoiding scalding to the emergency maintenance personnel who weld the seal plate, and at the same time, avoiding a localized water puddle formed by the continuously leaking water flow, which affects the efficiency of the following normal sealing of the thermal pipeline.
3. By welding the seal plate to the thermal pipeline to form the first weld seam, the sealing of the leak point on the large-diameter, high-temperature, high-pressure long-distance thermal pipeline is achieved, preventing continuous leak of high-temperature, high-pressure water between the seal plate and thermal pipeline after closing the on-off gate valve, thereby improving the efficiency and effectiveness of sealing the leak point on the thermal pipeline. Then closing the on-off gate valve on the drainage pipeline to block the high-temperature, high-pressure water by the valve plate, preventing leak of high-temperature, high-pressure water during following replacement of the flange plate, providing operational space for the emergency maintenance personnel to seal the drainage pipeline, while effectively reducing the risk of scalding by high-temperature water to the emergency maintenance personnel. Subsequently disconnecting the first flange from the second flange, removing the connecting pipeline from the drainage pipeline, then welding the valve plate and valve body of the on-off gate valve, installing the flange plate onto the first flange and applying the second weld seam, through the dual-layer welded sealing of the valve plate of the on-off gate valve and the flange plate, preventing subsequent continuous leak of high-temperature, high-pressure water between the drainage pipeline and flange plate, thereby further improving the efficiency and effectiveness of sealing the leak point on the thermal pipeline. Moreover, achieving sealing of the leak point on the thermal pipeline without pressure reduction, temperature decrease or pipeline shutdown, avoiding large-scale, long-duration heating interruption accidents, reducing the impact on normal life of residents in the heating area during the repair process of the thermal pipeline leak point. Meanwhile, enabling the emergency maintenance personnel to complete sealing with pressure of the thermal pipeline leak point without contacting the leaking high-temperature, high-pressure water, effectively reducing the risk of scalding by high-temperature water to the emergency maintenance personnel.
4. The first sealing strip on the seal plate possesses some degree of flexibility, which enables compensation for partial deviations in saddle-shaped seal devices of different pipe diameters when compressed by the force of the electromagnet, so that one model of seal device can be applied to scaling with pressure of multiple pipe diameters, thereby improving the versatility and applicability of the seal device. Additionally, the detachable connection between the drainage pipeline and connecting pipeline via the first and second flanges permits repeated use of both the connecting pipeline and drainage belt with different seal plates, reducing the variety and quantity of spare parts required. Furthermore, upon completion of each thermal pipeline leak point repair, the drainage belt does not need to be detached from the drainage opening, avoiding frequent installation/removal of the drainage belt that could over-expand the connection points of the drainage belt and affect sealing integrity between drainage belt and drainage opening, thereby further preventing high-temperature, high-pressure water from spraying out of the gap between the drainage belt and the drainage opening during the emergency repair process, and further reducing the risk of the emergency maintenance personnel being scalded by high-temperature water.
5. When sealing leak points in the large-diameter high-temperature, high-pressure long-distance thermal pipeline, the seal device is lifted via multiple lifting lugs provided on both sides of the seal plate, and the center of the seal plate is aligned to the leak point of the thermal pipeline, enabling the emergency maintenance personnel to complete sealing with pressure of the thermal pipeline leak point without contacting the high-temperature, high-pressure leaking water, thereby effectively reducing scalding risks to emergency maintenance personnel by high-temperature water. Furthermore, after the seal device is magnetically attached to the thermal pipeline via the electromagnet, the position of the seal plate can be finely adjusted by using the force-applying handle to ensure contact between the seal plate and thermal pipeline, preventing continuous leak of high-temperature, high-pressure water from gaps between the seal plate and thermal pipeline after closing the on-off gate valve, consequently improving both the efficiency and effectiveness of sealing the leak point of the thermal pipeline.
6. The seal plate is provided with multiple grid-shaped reinforcing ribs to enhance the overall rigidity and strength of the seal device, preventing subsequent re-leakage, thereby prolonging the operational effectiveness and service life of the thermal pipeline, while improving the efficiency and effectiveness of sealing the leak point of the thermal pipeline. Moreover, the seal plate is in an inverted flared shape to facilitate collection and rapid concentrated discharge of the drainage water, further enhancing the efficiency and effectiveness of sealing the leak point of the thermal pipeline.
7. Through the configuration of the electromagnet, seal plate, screw rod, through hole and nut, the electromagnet is detachably mounted on the seal plate, allowing easy removal of the electromagnet from the seal device after completion of sealing operations, thereby enabling repeated use of the electromagnet.
8. When it is necessary to connect the drainage pipeline and the connecting pipeline, the second flange is fixed to the first flange through the configuration among the first flange, second flange, penetrating hole, fixing rod, limit blocks, first inclined surfaces, reset spring and locking spring. Simultaneously, the rebound force generated by the compressed locking spring acts on the first flange and second flange through the fixing rod and limit blocks respectively, further compressing the third scaling strip between the first flange and second flange, thereby further enhancing the sealing between the flange plate and drainage pipeline to prevent subsequent continuous leak of high-temperature, high-pressure water from the gap between the flange plate and drainage pipeline, consequently improving the efficiency and effectiveness of sealing the leak point of the thermal pipeline. Moreover, the connection between the drainage pipeline and the connecting pipeline can be realized without screwing multiple nuts, simplifying the connection procedure between the drainage pipeline and connecting pipeline and thereby increasing the sealing efficiency at the leak point of the thermal pipeline.

Furthermore, after fixing the first flange and the second flange, the configuration among the screwdriver, fixing rod, locking block, conical surface, two limit blocks and second inclined surfaces generates resistance that restricts inward movement of the two limit blocks, preventing accidental movement of the limit blocks that could cause detachment of the first flange and second flange and affect the overall structural stability.

### BRIEF DESCRIPTION OF DRAWINGS

FIG. 1 is a schematic structural view of the seal plate according to the present disclosure.

FIG. 2 is a schematic structural view of the drainage pipeline according to the present disclosure.

FIG. 3 is a schematic structural view of the connecting pipeline according to the present disclosure.

FIG. 4 is a partial enlarged view of section A in FIG. 2 according to the present disclosure.

FIG. 5 is a partial enlarged view of section C in FIG. 2 according to the present disclosure.

FIG. 6 is a partial enlarged view of section B in FIG. 2 according to the present disclosure.

FIG. 7 is a schematic structural view of the flange plate according to the present disclosure.

### LIST OF REFERENCE SIGNS

thermal pipeline 1; seal plate 2; electromagnet 3; first sealing strip 4; drainage pipeline 5; first flange 6; drainage belt 7; connecting pipeline 8; second flange 9; drainage opening 10; on-off gate valve 11; flange plate 12; first weld seam 13;
force-applying handle 14; lifting lug 15; second sealing strip 16; sealing groove 17; second weld seam 18; third sealing strip 19; reinforcing rib 20; protrusion 21; fourth sealing strip 22; clamp 23; screw rod 24; through hole 25; nut 26;
fixing rod 27; penetrating hole 28; locking spring 29; limit block 30; first inclined surface 31; reset spring 32; locking block 33; second inclined surface 34; conical surface 35.

### DESCRIPTION OF EMBODIMENTS

The present disclosure will be further described below with reference to specific embodiments. It should be understood that these embodiments are provided for illustrating the application only and not for limiting the scope of the present disclosure. Furthermore, it should be understood that after reading the teachings of the present disclosure, those skilled in the art may make various modifications or alterations to the application, and such equivalent forms shall similarly be within the scope defined by this application.

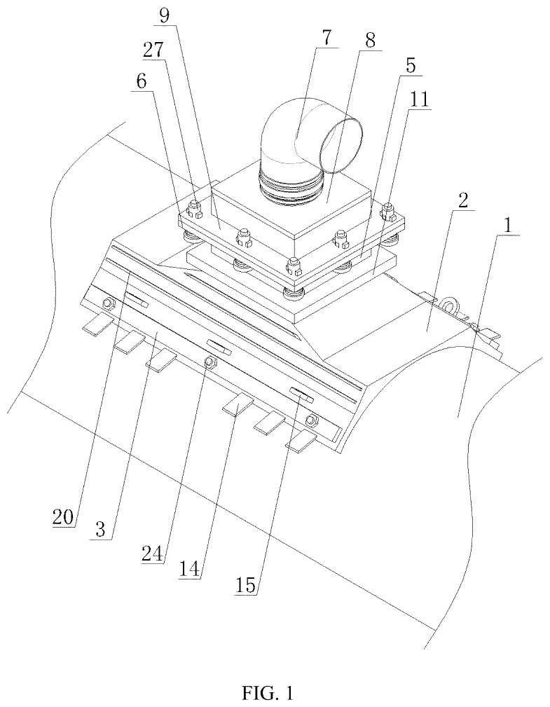

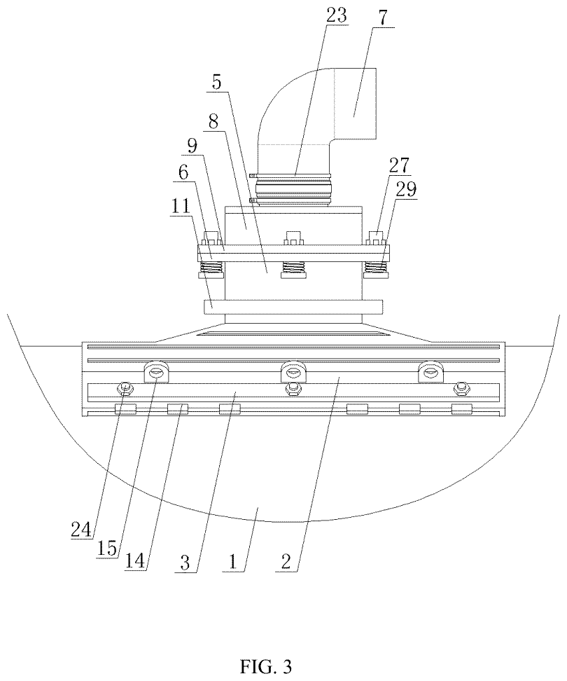

The present invention provides a pressure seal device for large-diameter high-temperature, high-pressure, long-distance thermal pipeline, as shown in FIGS. 1, 2, 3 and 7, including a seal plate 2 covering a leak point of a thermal pipeline 1, wherein the seal plate 2 is provided with an electromagnet 3 used for engaging with the thermal pipeline 1 and a first sealing strip 4 in contact with the thermal pipeline 1. When a leak point occurs in the thermal pipeline 1, the seal device is placed on the thermal pipeline 1 with the center of the seal plate 2 positioned at the leak point. By energizing the electromagnet 3 on the seal plate 2, the electromagnet 3 generates magnetic force to attach the seal plate 2 onto the thermal pipeline 1. Meanwhile, compressing the first sealing strip 4 between the seal plate 2 and thermal pipeline 1 to achieve temporary seal at the leak point of the thermal pipeline 1, preventing continuous leak of the high-temperature, high-pressure water from the leak point of the thermal pipeline 1 that may cause scalding to the emergency maintenance personnel. The seal plate 2 is provided with a drainage pipeline 5, and one end of the drainage pipeline 5 is provided with a first flange 6. The seal device further includes a drainage belt 7 and a connecting pipeline 8. One end of the connecting pipeline 8 is provided with a second flange 9 detachably connected to the first flange 6, and the other end of the connecting pipeline 8 is provided with a drainage opening 10. The drainage belt 7 is mounted around the drainage opening 10. The drainage pipeline 5 is provided with an on-off gate valve 11, and by opening the on-off gate valve 11 on the drainage pipeline 5, the high-temperature, high-pressure water conveyed by the thermal pipeline 1 sequentially passes through the drainage pipeline 5 and the connecting pipeline 8, and is diverted to a safe area through the large-diameter drainage opening 10 and the drainage belt 7, thereby relieving the pressure of high-temperature, high-pressure water acting on the seal plate 2 and preventing the high-temperature, high-pressure water from directly washing away the seal plate 2; meanwhile preventing partial high-temperature, high-pressure water from breaking through the sealing of the first sealing strip 4 and leaking through the gap between the seal plate 2 and thermal pipeline 1, which may cause scalding to emergency maintenance personnel welding the seal plate; also preventing continuously leaking water from forming puddles that may affect following normal seal efficiency of the thermal pipeline 1. The seal device further includes a flange plate 12 detachably connected to the first flange 6, and a first weld seam 13 is provided between the seal plate 2 and thermal pipeline 1. Though welding the seal plate 2 to the thermal pipeline 1 by the emergency maintenance personnel, the first weld seam 13 is formed to achieve seal at the leak point of the thermal pipeline 1, preventing continuous leak of high-temperature, high-pressure water from the gap between the seal plate 2 and thermal pipeline 1 after closing the on-off gate valve 11, thereby improving the efficiency and effectiveness of sealing the leak point of the thermal pipeline 1.

Preferably, as shown in FIGS. 1, 2, 3 and 4, both sides of the seal plate 2 are respectively provided with multiple force-applying handles 14 and lifting lugs 15. Through the lifting lugs 15, the seal device can be lifted and the center of the seal plate 2 can be aligned to the leak point of the thermal pipeline 1, enabling emergency maintenance personnel to complete seal with pressure of the thermal pipeline 1 leak point without contacting the high-temperature, high-pressure leaking water, thereby effectively reducing the risk of scalding to emergency maintenance personnel by high-temperature water. Simultaneously, through minor positional adjustments of the seal plate 2 by using the force-applying handle 14, the seal plate 2 can be closely fitted to the thermal pipeline 1, preventing continuous leak of high-temperature, high-pressure water from the gap between the seal plate 2 and thermal pipeline 1 after closing the on-off gate valve 11, consequently improving the efficiency and effectiveness of sealing the leak point of the thermal pipeline 1.

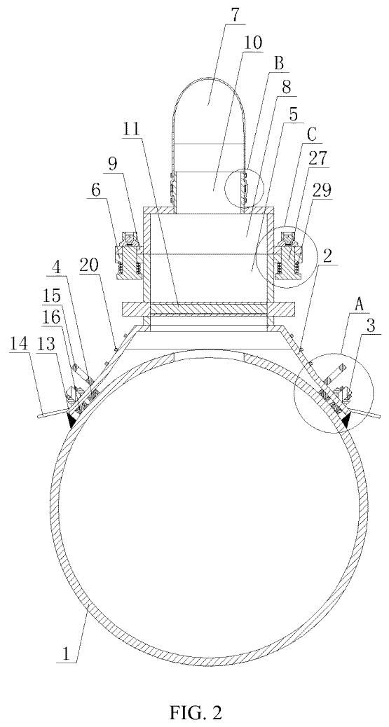

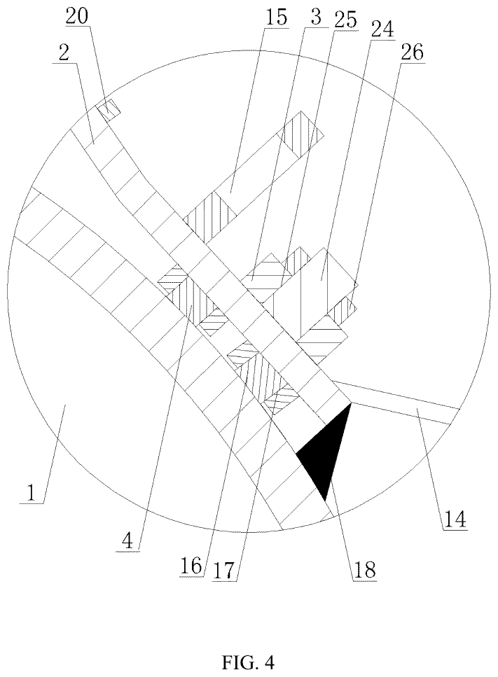

Preferably, as shown in FIGS. 2 and 4, a second sealing strip 16 is arranged between the seal plate 2 and the thermal pipeline 1. The second sealing strip 16 is spaced apart from the first sealing strip 4 by a distance, so that when high-temperature, high-pressure water in the thermal pipeline 1 breaks through the first sealing strip 4, it will be contained between the first sealing strip 4 and the second sealing strip 16, thereby further confining the leaking water at the leak point within the seal plate 2 and diverting the high-temperature, high-pressure water to a safe area through the drainage belt 7, which prevents the leak of high-temperature water around the seal device and provides a safe working space for the next welding operation by emergency maintenance personnel, further reducing the risk of scalding to emergency maintenance personnel. The seal plate 2 is provided with sealing grooves 17, and the first sealing strip 4 and the second sealing strip 16 are embedded in the sealing grooves 17 on the seal plate 2, effectively preventing damage to the sealing strips caused by the high-temperature, high-pressure leaking water when the seal device closes to the leak point.

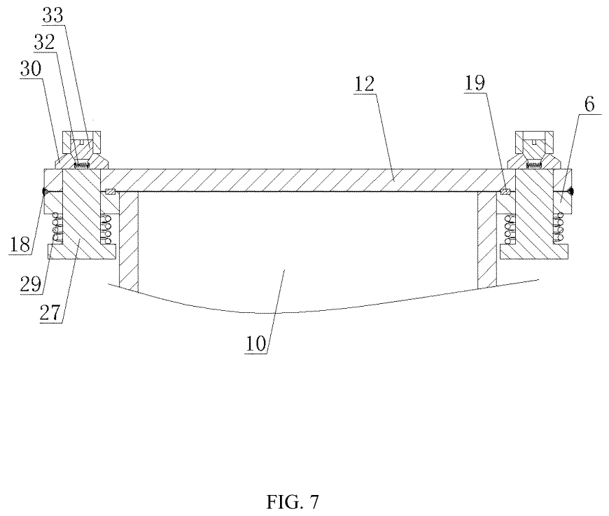

Preferably, as shown in FIG. 7, a second weld seam 18 and a third sealing strip 19 are arranged between the flange plate 12 and the first flange 6, achieving dual-layer welded sealing of the valve plate of the on-off gate valve 11 and the flange plate 12, preventing subsequent continuous leak of high-temperature, high-pressure water from the gap between the drainage pipeline 5 and the flange plate 12, thereby improving the efficiency and effectiveness of sealing the leak point of the thermal pipeline 1.

Preferably, as shown in FIGS. 1, 2 and 4, the seal plate 2 is provided with multiple grid-shaped reinforcing ribs 20 to enhance the overall rigidity and strength of the seal device, preventing subsequent re-leakage, thereby prolonging the operational effectiveness and service life of the thermal pipeline I while improving the efficiency and effectiveness of sealing the leak point; the seal plate 2 is in an inverted flared shape to facilitate collection and rapid concentrated discharge of the drainage water, further enhancing the efficiency and effectiveness of sealing the leak point of the thermal pipeline 1.

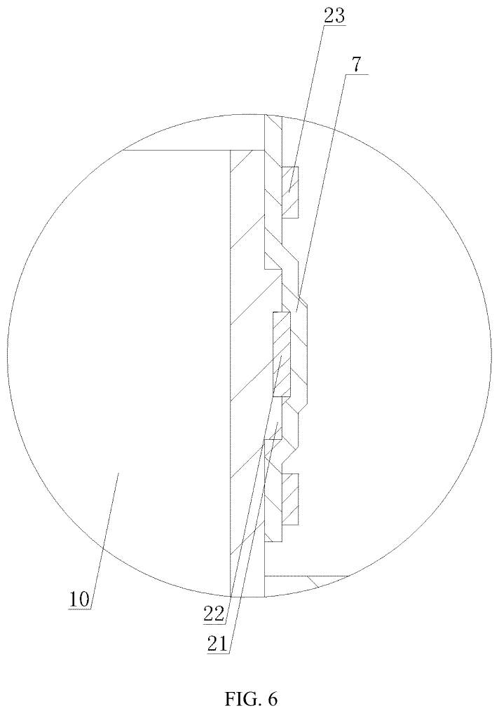

Preferably, as shown in FIGS. 2 and 6, the drainage opening 10 is provided with a protrusion 21. The protrusion 21 is provided with a fourth sealing strip 22 in contact with the drainage belt 7. The outer side of the drainage belt 7 is respectively sleeved with two clamps 23, and the two clamps 23 is respectively arranged on upper and lower sides of the protrusion 21. Though expanding the drainage belt 7 by the protrusion 21 and compressing the fourth sealing strip 22 between the drainage belt 7 and the drainage opening 10, the sealing between the drainage opening 10 and the drainage belt 7 is further improved, so as to prevent continuous leak of high-temperature, high-pressure water from the gap between the drainage outlet 10 and the drainage belt 7 when diverting the high-temperature, high-pressure water to a safe area, thereby avoiding scalding of the emergency maintenance personnel by the high-temperature, high-pressure leaking water and consequently improving the efficiency and effectiveness of sealing the leak point of the thermal pipeline 1. Moreover, the two clamps 23 limit the position of the drainage belt 7 on the water inlet, effectively preventing the drainage belt 7 from detaching from the drainage opening 10 and further avoiding scalding of the emergency maintenance personnel by the high-temperature, high-pressure leaking water.

Preferably, as shown in FIGS. 2 and 4, the seal plate 2 is provided with multiple screw rods 24. The electromagnet 3 is provided with multiple through holes 25 for the screw rods 24 to pass through, and each screw rod 24 is threadedly connected with a nut 26 contacting the electromagnet 3, thereby detachably mounting the electromagnet 3 on the seal plate 2 to facilitate removal of the electromagnet 3 from the seal device after completion of sealing operations, enabling repeated use of the electromagnet 3.

Preferably, as shown in FIG. 1, the seal plate 2 is made of steel plates welded together. Since carbon steel plates have higher strength, rigidity and service life than the thermal pipeline 1, the seal plate 2 can achieve permanent protection for the thermal pipeline 1 after successful sealing by the seal plate 2, and affects the overall operational effectiveness and service life of the long-distance pipeline, preventing subsequent re-leak and consequently improving the efficiency and effectiveness of sealing the leak point of the thermal pipeline 1.

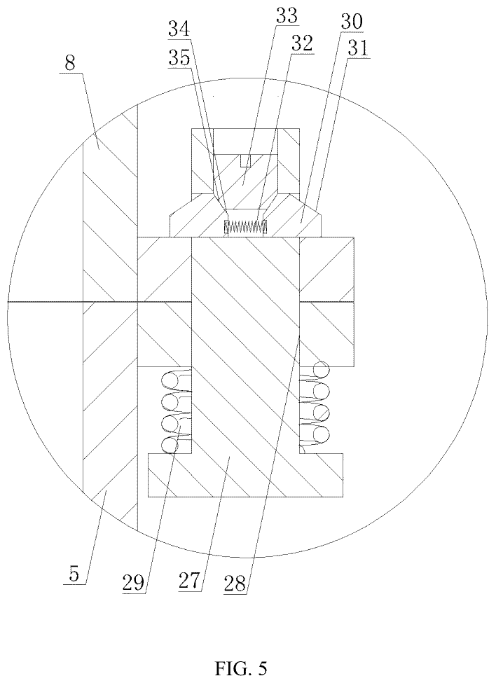

Preferably, as shown in FIGS. 2, 5 and 7, the device further includes multiple fixing rods 27. Each of the first flange 6, second flange 9 and flange plate 12 is respectively provided with multiple penetrating holes 28 for the fixing rods 27 to pass through. A locking spring 29 is arranged between each fixing rod 27 and the first flange 6. Two limit blocks 30 are slidably connected to an end of each fixing rod 27 and are arranged symmetrically. One side of each limit block 30 contacts either the second flange 9 or the flange plate 12, the other side of each limit block 30 is provided with a first inclined surface 31 contacting the first flange 6, second flange 9 and flange plate 12. A reset spring 32 is arranged between the two limit blocks 30. When it is necessary to connect the drainage pipeline 5 and connecting pipeline 8, the penetrating holes 28 on the first flange 6 and the second flange 9 are aligned, then a fixing rod 27 is sequentially inserted through a penetrating hole 28 of both the first flange 6 and the second flange 9. Each first inclined surfaces 31 of the two limit blocks 30 contacts the first flange 6, generating component forces that drive the two limit blocks 30 to move inward and compress a reset spring 32 between them. A fixing rod 27 is then moved and a locking spring 29 between the fixing rod 27 and the first flange 6 is compressed until the two limit blocks 30 slide past the second flange 9. The restoring force of the reset spring 32 then drives the two limit blocks 30 to move outward, causing the other side of each of the two limit blocks 30 to contact the second flange 9. The resistance generated after contact combined with the restoring force from the compressed locking spring 29 prevents further movement of the fixing rod 27 relative to the first flange 6, thereby fixing the second flange 9 to the first flange 6. Simultaneously, the restoring force from the compressed locking spring 29 acts on both the first flange 6 and the second flange 9 through the fixing rods 27 and limit blocks 30, further compressing the third sealing strip 19 between the first flange 6 and second flange 9, thereby enhancing the sealing between the flange plate 12 and drainage pipeline 5 to prevent subsequent leak of high-temperature, high-pressure water from gap between the flange plate 12 and drainage pipeline 5, consequently improving the efficiency and effectiveness of sealing the leak point of the thermal pipeline 1. Moreover, the connection between the drainage pipeline 5 and the connecting pipeline 8 can be realized without screwing multiple nuts 26, simplifying the connection procedure between the drainage pipeline 5 and connecting pipeline 8 and thereby increasing the sealing efficiency at the leak point of the thermal pipeline 1. The connection and disconnection between the first flange 6 and the flange plate 12 can be realized by the same principle as described above.

Preferably, as shown in FIGS. 2, 5 and 7, an end of a fixing rod 27 is threadedly connected with a locking block 33, an end of each of two limit blocks 30 is provided with a second inclined surface 34, and an end of the locking block 33 is provided with a conical surface 35 contacting the two second inclined surfaces 34. After fixing the first flange 6 and second flange 9, the locking block 33 is rotated at the end of the fixing rod 27 by using a screwdriver, so as to make the locking block 33 move along the fixing rod 27 until the conical surface 35 contacts the second inclined surface 34 of each of the two limit blocks 30 respectively, thereby generating resistance that restricts inward movement of the two limit blocks 30, preventing accidental movement of the two limit blocks 30 that could cause detachment of the first flange 6 and second flange 9, affecting the overall structural stability.

### Embodiment 1

The present invention provides a pressure seal device for large-diameter high-temperature, high-pressure, long-distance thermal pipeline, as shown in FIGS. 1, 2, 3 and 7. Through the detachable connection between the first flange 6 and the second flange 9 enables pre-assembly of the connecting pipeline 8 with the drainage pipeline 5, and the drainage belt 7 is mounted around the drainage opening 10, so as to complete the pre-assembly of the seal device, which facilitates rapid sealing of the leak point of the large-diameter high-temperature, high-pressure, long-distance thermal pipeline 1, and improves the sealing efficiency of the thermal pipeline 1.

When a leak point occurs in the thermal pipeline 1, the seal device is placed on the thermal pipeline 1 with the center of the seal plate 2 positioned at the leak point. By energizing the electromagnet 3 on the seal plate 2, the electromagnet 3 generates magnetic force to attach the seal plate 2 onto the thermal pipeline 1. Meanwhile, compressing the first sealing strip 4 between the seal plate 2 and thermal pipeline 1 to achieve temporary seal at the leak point of the thermal pipeline 1, preventing continuous leak of the high-temperature, high-pressure water from the leak point of the thermal pipeline 1 that may cause scalding to the emergency maintenance personnel. The leaking high-temperature, high-pressure water is then diverted through the drainage pipeline 5, and flows into the connecting pipeline 8 connected to the drainage pipeline 5 via the on-off gate valve 11 which is in an open state before sealing the leak, and is channeled to a safe area through the large-diameter drainage opening 10 and drainage belt 7, thereby relieving the pressure applied by the high-temperature, high-pressure water on the seal plate 2 and preventing the water from directly washing away the seal plate 2; meanwhile preventing partial high-temperature, high-pressure water from breaking through the scaling of the first sealing strip 4 and leaking through the gap between the seal plate 2 and thermal pipeline 1, which may cause scalding to emergency maintenance personnel welding the seal plate; also preventing continuously leaking water from forming puddles that may affect following normal seal efficiency of the thermal pipeline 1. Subsequently, though welding the seal plate 2 to the thermal pipeline 1 by the emergency maintenance personnel, the first weld seam 13 is formed to achieve seal at the leak point of the thermal pipeline 1, preventing continuous leak of high-temperature, high-pressure water from the gap between the seal plate 2 and thermal pipeline I after closing the on-off gate valve 11, thereby improving the efficiency and effectiveness of sealing the leak point of the thermal pipeline 1.

Finally the on-off gate valve 11 welded to the drainage pipeline 5 is closed, and the valve plate is weld to the valve body, blocking the high-temperature, high-pressure water by the valve plate to prevent leak of high-temperature, high-pressure water during following replacement of the flange plate 12, thereby providing operational space for the emergency maintenance personnel to seal the drainage pipeline 5, while effectively reducing the risk of scalding by high-temperature water to the emergency maintenance personnel. Subsequently, the connection between the first flange 6 and the second flange 9 is disengaged, connecting pipeline 8 is detached from the drainage pipeline 5, and the flange plate 12 is installed onto the first flange 6. Through the dual-layer welded scaling of the valve plate of the on-off gate valve 11 and the flange plate 12, subsequent continuous leak of high-temperature, high-pressure water between the drainage pipeline 5 and flange plate 12 is prevented, thereby further improving the efficiency and effectiveness of sealing the leak point on the thermal pipeline 1. Moreover, achieving sealing of the leak point on the thermal pipeline 1 without pressure reduction, temperature decrease or pipeline shutdown, avoiding large-scale, long-duration heating interruption accidents, reducing the impact on normal life of residents in the heating area during the repair process of the leak point of the thermal pipeline 1. Meanwhile, enabling the emergency maintenance personnel to complete scaling with pressure of the thermal pipeline 1 leak point without contacting the leaking high-temperature, high-pressure water, effectively reducing the risk of scalding by high-temperature water to the emergency maintenance personnel.

In addition, the first sealing strip 4 on the seal plate 2 possesses some degree of flexibility, which enables compensation for partial deviations in saddle-shaped seal devices of different pipe diameters when compressed by the force of the electromagnet 3, so that one model of seal device can be applied to sealing with pressure of multiple pipe diameters, thereby improving the versatility and applicability of the seal device. Additionally, the detachable connection between the drainage pipeline 5 and connecting pipeline 8 via the first flange 6 and second flange 9 permits repeated use of both the connecting pipeline 8 and drainage belt 7 with different seal plates, reducing the variety and quantity of spare parts required. Furthermore, upon completion of each thermal pipeline 1 leak point repair, the drainage belt 7 does not need to be detached from the drainage opening 10, avoiding frequent installation/removal of the drainage belt 7 that could over-expand the connection points of the drainage belt 7 and affect sealing integrity between drainage belt 7 and drainage opening 10, thereby further preventing high-temperature, high-pressure water from spraying out of the gap between the drainage belt 7 and the drainage opening 10 during the emergency repair process, and further reducing the risk of the emergency maintenance personnel being scalded by high-temperature water.

### Embodiment 2

On the basis of the embodiment 1, as shown in FIGS. 1, 2, 3, and 4, when scaling the leak point of the thermal pipeline 1, a hook may be engaged with the lifting lug 15 on the inner side of the seal plate 2, thereby lifting the seal device and aligning the center of the seal plate 2 with the leak point of the thermal pipeline 1. This enables the emergency maintenance personnel to complete the sealing with pressure of the leak point of the thermal pipeline 1 without contacting the high-temperature, high-pressure leaking water, effectively reducing the risk of the emergency maintenance personnel being scalded by high-temperature water. Additionally, after the seal device is magnetically attached to the thermal pipeline 1 via the electromagnet 3, the position of the seal plate 2 can be slightly adjusted by using the force-applying handle 14, ensuring that the seal plate 2 closely fits the thermal pipeline 1. This prevents continuous leak of high-temperature, high-pressure water from the gap between the plugging plate 2 and the thermal pipeline 1 after closing the on-off gate valve 11, thereby improving the efficiency and effectiveness of scaling the leak point of the thermal pipeline 1.

Additionally, the seal plate 2 is provided with multiple grid-shaped reinforcing ribs 20 to enhance the overall rigidity and strength of the seal device, preventing subsequent re-leakage, thereby prolonging the operational effectiveness and service life of the thermal pipeline 1 while improving the efficiency and effectiveness of sealing the leak point; the seal plate 2 is in an inverted flared shape to facilitate collection and rapid concentrated discharge of the drainage water, further enhancing the efficiency and effectiveness of sealing the leak point of the thermal pipeline 1.

### Embodiment 3

On the basis of the embodiment 1, as shown in FIGS. 2 and 4, before sealing the leak point of the thermal pipeline 1, the electromagnets 3 are positioned on both sides of the seal plate 2. This ensures that the multiple screw rods 24 provided on the seal plate 2 align with the through holes 25 on the electromagnets 3. The electromagnets 3 are then passed over the screw rods 24 and attached onto the seal plate 2. Subsequently, nuts 26 are threaded onto the screw rods 24 and tightened until they come into contact with the electromagnets 3, thereby detachably mounting the electromagnet 3 on the seal plate 2 to facilitate removal of the electromagnet 3 from the seal device after completion of scaling operations, enabling repeated use of the electromagnet 3.

### Embodiment 4

On the basis of the embodiment 1, as shown in FIGS. 2, 5, and 7, when it is necessary to connect the drainage pipeline 5 and connecting pipeline 8, the penetrating holes 28 on the first flange 6 and the second flange 9 are aligned, then a fixing rod 27 is sequentially inserted through a penetrating hole 28 of both the first flange 6 and the second flange 9. Each first inclined surfaces 31 of the two limit blocks 30 contacts the first flange 6, generating component forces that drive the two limit blocks 30 to move inward and compress a reset spring 32 between them. A fixing rod 27 is then moved and a locking spring 29 between the fixing rod 27 and the first flange 6 is compressed until the two limit blocks 30 slide past the second flange 9. The restoring force of the reset spring 32 then drives the two limit blocks 30 to move outward, causing the other side of each of the two limit blocks 30 to contact the second flange 9. The resistance generated after contact combined with the restoring force from the compressed locking spring 29 prevents further movement of the fixing rod 27 relative to the first flange 6, thereby fixing the second flange 9 to the first flange 6. Simultaneously, the restoring force from the compressed locking spring 29 acts on both the first flange 6 and the second flange 9 through the fixing rods 27 and limit blocks 30, further compressing the third sealing strip 19 between the first flange 6 and second flange 9, thereby enhancing the sealing between the flange plate 12 and drainage pipeline 5 to prevent subsequent leak of high-temperature, high-pressure water from gap between the flange plate 12 and drainage pipeline 5, consequently improving the efficiency and effectiveness of sealing the leak point of the thermal pipeline 1. Moreover, the connection between the drainage pipeline 5 and the connecting pipeline 8 can be realized without screwing multiple nuts 26, simplifying the connection procedure between the drainage pipeline 5 and connecting pipeline 8 and thereby increasing the sealing efficiency at the leak point of the thermal pipeline 1. Additionally, after fixing the first flange 6 and second flange 9, the locking block 33 is rotated at the end of the fixing rod 27 by using a screwdriver, so as to make the locking block 33 move along the fixing rod 27 until the conical surface 35 contacts the second inclined surface 34 of each of the two limit blocks 30 respectively, thereby generating resistance that restricts inward movement of the two limit blocks 30, preventing accidental movement of the two limit blocks 30 that could cause detachment of the first flange 6 and second flange 9, affecting the overall structural stability.

After completing the sealing operation with the seal device, the locking block 33 can be loosened. The two limit blocks 30 on both sides can be pressed inward, which causes the two limit blocks 30 to move inward until the fixing rod 27 slides under the spring force of the locking spring 29 and slides out of the first flange 6 and the second flange 9. As a result, the fixation between the first flange 6 and the second flange 9 is released without screwing multiple nuts, simplifying the disconnection procedure between the drainage pipeline 5 and connecting pipeline 8 and thereby increasing the sealing efficiency at the leak point of the thermal pipeline 1

The connection and disconnection between the first flange 6 and the flange plate 12 can be realized by the same principle as described above.

What is claimed is:

1. A pressure seal device for large-diameter high-temperature, high-pressure, long-distance thermal pipeline, comprising a seal plate (2) covering a leak point of a thermal pipeline (1), wherein the seal plate (2) is provided with an electromagnet (3) to be engaged with the thermal pipeline (1), and a first sealing strip (4) in contact with the thermal pipeline (1), the seal plate (2) is provided with a drainage pipeline (5), and one end of the drainage pipeline (5) is provided with a first flange (6); the pressure seal device further comprises a drainage belt (7) and a connecting pipeline (8), wherein one end of the connecting pipeline (8) is provided with a second flange (9) detachably connected to the first flange (6), and an other end of the connecting pipeline (8) is provided with a drainage opening (10), the drainage belt (7) is mounted around the drainage opening (10), the drainage pipeline (5) is provided with an on-off gate valve (11); the pressure seal device further comprises a flange plate (12) detachably connected to the first flange (6), a first weld seam (13) is provided between the seal plate (2) and the thermal pipeline (1);
the pressure seal device further comprises a plurality of fixing rods (27), each of the first flange (6), the second flange (9), and the flange plate (12) is provided with a plurality of penetrating holes (28) for the plurality of fixing rods (27) to pass through; a locking spring (29) is provided between each fixing rod (27) and the first flange (6); two limit blocks (30) are slidably and symmetrically connected to an end of each fixing rod (27), one side of each limit block (30) contacts the second flange (9) or the flange plate (12) respectively, and an other side of each limit block (30) is provided with a first inclined surface (31) contacting the first flange (6), the second flange (9), and the flange plate (12); a reset spring (32) is provided between the two limit blocks (30);
a locking block (33) is threadedly connected to an end of each fixing rod (27), an end of each limit block (30) is provided with a second inclined surface (34), and an end of each locking block (33) is provided with a conical surface (35) in contact with a corresponding second inclined surface (34).

2. The pressure seal device for large-diameter high-temperature, high-pressure, long-distance thermal pipeline according to claim 1, wherein both sides of the seal plate (2) are respectively provided with a plurality of force-applying handles (14) and lifting lugs (15).

3. The pressure seal device for large-diameter high-temperature, high-pressure, long-distance thermal pipeline according to claim 1, wherein a second sealing strip (16) is provided between the seal plate (2) and the thermal pipeline (1), and the second sealing strip (16) is spaced apart from the first sealing strip (4) by a distance; the seal plate (2) is provided with sealing grooves (17), and the first sealing strip (4) and the second sealing strip (16) are embedded in the sealing grooves (17) of the seal plate (2).

4. The pressure seal device for large-diameter high-temperature, high-pressure, long-distance thermal pipeline according to claim 1, wherein a second weld seam (18) and a third sealing strip (19) are provided between the flange plate (12) and the first flange (6).

5. The pressure seal device for large-diameter high-temperature, high-pressure, long-distance thermal pipeline according to claim 1, wherein the seal plate (2) is provided with a plurality of grid-shaped reinforcing ribs (20), and the seal plate (2) is in an inverted flared shape.

6. The pressure seal device for large-diameter high-temperature, high-pressure, long-distance thermal pipeline according to claim 1, wherein the drainage opening (10) is provided with a protrusion (21), and the protrusion (21) is provided with a fourth sealing strip (22) in contact with the drainage belt (7); two clamps (23) are respectively mounted around the drainage belt (7), and the two clamps (23) are respectively located above and below the protrusion (21).

7. The pressure seal device for large-diameter high-temperature, high-pressure, long-distance thermal pipeline according to claim 1, wherein the seal plate (2) is provided with a plurality of screw rods (24), and the electromagnet (3) is provided with a plurality of through holes (25) for the screw rods (24) to pass through; each screw rod (24) is threadedly connected with a nut (26) that is in contact with the electromagnet (3).

8. The pressure seal device for large-diameter high-temperature, high-pressure, long-distance thermal pipeline according to claim 1, wherein the seal plate (2) is made of steel plates welded together.
